(19) United States
(12) Patent Application Publication
(10) Pub. No.: US 2011/0157658 A1
(43) Pub. Date: Jun. 30, 2011

(54) IMAGING PROCESSING APPARATUS, METHOD FOR CONTROLLING THE SAME, AND PROGRAM

(75) Inventor: Tsuyoshi Yokomizo, Tokyo (JP)

(73) Assignee: CANON KABUSHIKI KAISHA, Tokyo (JP)

(21) Appl. No.: 12/973,755

(22) Filed: Dec. 20, 2010

(30) Foreign Application Priority Data
Dec. 24, 2009 (JP) 2009-292838

(51) Int. Cl. H04N 1/04

(52) U.S. Cl. 358/474

(57) ABSTRACT

An apparatus extracts information from a instruction sheet serving as a document in which an instruction for a area in a target document and a processing content for the area, reads a first ticket to which an image coded into a format recognizable by the apparatus and a thumbnail image of the document are added, and performs processing extracted from information added to the first ticket. The apparatus includes a comparison unit configured to compare a second ticket, obtained by adding new information to the first ticket, with the first ticket, and a generation unit configured to regenerate, if pieces of information included in the tickets differ in the comparison unit, the second ticket.

### BACKGROUND OF THE INVENTION

1. Field of the Invention

The present invention relates to an image processing apparatus which extracts additional information added to a document and a method for controlling the same and a program.

2. Description of the Related Art

Conventionally, a technique for reading a document such as a form with a scanner and extracting an amount and a date described in the document has been known. The use of this technique enables data extracted from a large number of forms to be used for processing such as counting. However, it is to be recognized which position in the form data exists and what is the data in order for the scanner to automatically perform the processing such as counting.

Japanese Patent Application Laid-Open No. 2008-145611, for example, discusses entering processing instruction information representing an area to be processed and a content of processing to which the area is subjected into a document to be processed by hand, and reading the entered processing instruction information with a scanner, to generate a processing instruction sheet for specifying the area to be processed and the content of the processing.

Japanese Patent Application Laid-Open No. 2008-145611 discusses representing the processing instruction information as symbols such as crossbars, vertical bars, and dots or characters, to indicate a processing content using the symbols or the characters in generating the processing instruction sheet. However, it is not considered that the processing content is changed.

### SUMMARY OF THE INVENTION

According to an aspect of the present invention, an apparatus extracts information from an instruction sheet serving as a document in which an instruction for a target area in a target document and a processing content for the area, reads a first ticket to which an image coded into a format recognizable by the apparatus and a thumbnail image of the document are added, and performs processing extracted from information added to the first ticket. The apparatus includes a comparison unit configured to compare a second ticket, obtained by adding new information to the first ticket, with the first ticket, and a generation unit configured to regenerate, if pieces of information included in the tickets differ in the comparison unit, the second ticket.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image processing apparatus.

FIG. 2 illustrates examples of documents to be processed.

FIG. 3 is a flowchart illustrating a flow of processing for generating a scan ticket.

FIG. 4 illustrates an example of a scan ticket to be processed.

FIG. 5 illustrates an example of a scan ticket to be processed to which an instruction is added.

FIG. 6 is a flowchart illustrating a flow of processing for regenerating a scan ticket.

FIG. 7 is a flowchart illustrating a flow of processing for regenerating a scan ticket.

FIG. 8 illustrates an example of a screen of an operation unit for displaying, when an instruction is added to a scan ticket, its content.

FIG. 9 is a flowchart illustrating a flow of processing for regenerating a scan ticket.

FIG. 10 is a flowchart illustrating a flow of processing for regenerating a scan ticket.

### DESCRIPTION OF THE EMBODIMENTS

Various exemplary embodiments, features, and aspects of the invention will be described in detail below with reference to the drawings.

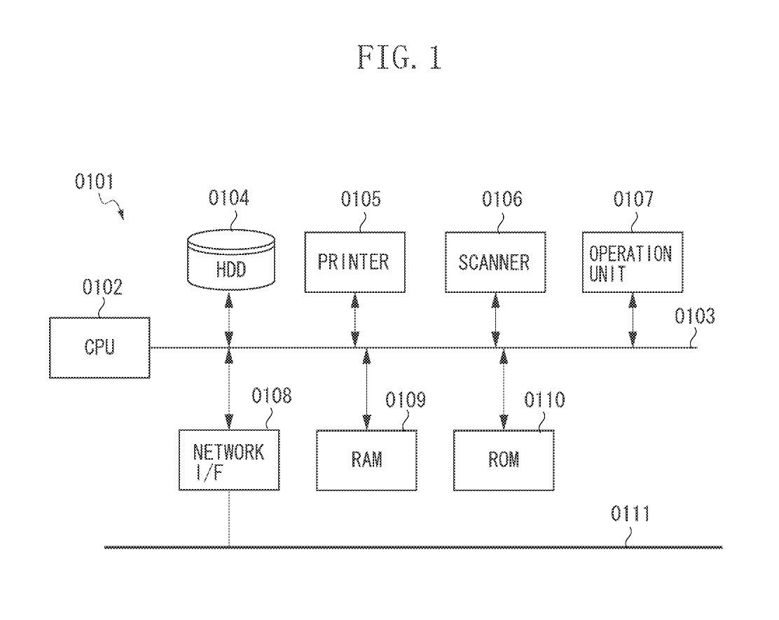

FIG. 1 is block diagram illustrating a configuration of an image processing apparatus according to a first exemplary embodiment of the present invention. An image processing apparatus 0101 according to the present exemplary embodiment is exemplified in a multifunction peripheral provided with various functions such as a copying function and a scanner function. A plurality of apparatuses may cooperate with one another, to implement the functions.

A central processing unit (CPU) 0102 controls the entire operation of the image processing apparatus 0101 by loading a program stored in a read-only memory (ROM) 0110 into a random access memory (RAM) 0109. The CPU 0102 communicates with each component in the image processing apparatus 0101 via a bus 0103. An operation unit 0107 includes a plurality of keys for a user to give an instruction, and a display unit for displaying various types of information to be notified the user. A scanner 0106 serving as a reading device reads an image on a document set on a document positioning plate as a color image, and stores electronic data (image data) obtained by the reading in a hard disk drive (HDD) 0104 and the RAM 0109.

The HDD 0104 includes a hard disk, and stores input various types of information. The scanner 0106 includes a document feeding device, and can sequentially feed a plurality of documents set on the document feeding device to the document positioning plate, and read the documents. A printer 0105 serving as a printing device prints an image based on input image data on recording paper (a sheet). A network interface (I/F) 0108 connects the image processing apparatus 0101 to a network 0111, and controls reception of data from an external apparatus on the network 0111 and transmission of data to the external apparatus on the network 0111.

In the present exemplary embodiment, image data used for processing, described below, is input via the scanner 0106. In addition, image data representing a document transmitted from the external apparatus, for example, can similarly be processed even if it is input via the network I/F 0108. In a personal computer (PC) to which a scanner and a printer are connected, the image data can similarly be processed. In this case, the whole or a part of a program used in the present exemplary embodiment can be provided to the PC via the network and provided to the PC after being stored in a storage medium such as a compact disk (CD)-ROM.

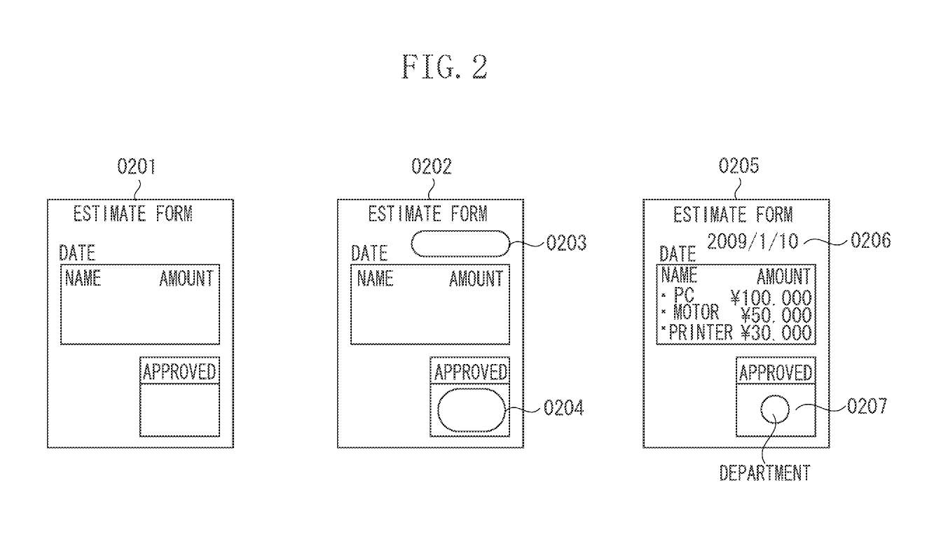

An example of a document used in the present exemplary embodiment will be described below. FIG. 2 illustrates examples of documents used in the present exemplary embodiment. A document 0201 is an estimate form (a form document) in which nothing is entered by a user (to which processing instruction information, described below, has not been added yet). The estimate form includes a date column, a name column, an amount column, and an area in which an approver' s seal is to be put. When the estimate form is formally issued, the user describes each content.

In the present exemplary embodiment, the user checks, among the columns in the estimate form, whether a correct date has been entered in the date column and a correct seal has been put in the area in which the approver's seal is to be put.

A document 0202 is an example in which the user adds arbitrary processing target areas to be checked among items included in the document 0201 with a color pen. The document 0202 is a processing instruction sheet.

The user who checks the generated estimate form writes processing instruction information described below into a sheet with a similar format to that of the estimate form serving as a processing target document, so that the processing instruction sheet is generated. More specifically, a processing target area is surrounded as a closed area such as a rectangle with a color pen or the like by the user to designate the area in the document 0201. Thus, the document 0202 with the surrounded areas is regarded as the processing instruction sheet.

The processing instruction information to be written into the document 0201 serving as an estimate form (a form document) will be described below. In the document 0202, it is assumed that the processing instruction information is written into an area 0203 with a blue pen, and is written into an area 0204 with a red pen. Colors other than the blue and red can also be used. Further, the number of colors is not limited to two. The number of colors may be decreased or increased according to check contents. While the pen is used in this example, something other than the pen may be used as long as it gives a color.

The user associates information relating to a color and a processing content in the processing instruction information to be used with each other and registers them in the RAM 0109 using the operation unit 0107 in advance. A closed area surrounded with a color pen is subjected to processing corresponding to the color of the pen. More specifically, a content of processing for checking whether a date is correctly entered in an area surrounded in blue and a content of processing for checking whether a seal is correctly put in an area surrounded in red are respectively registered in the RAM 0109.

A document 0205 is an example of a document to be checked which is used in the present exemplary embodiment. It is supposed that the document to be checked is based on a document in a similar format to those of the documents 0201 and 0202. In the present exemplary embodiment, the processing instruction sheet 0202 issues an instruction to check whether a date is correctly described in the area 0203 and a seal is correctly put in the area 0204. Therefore, a date 0206 and a seal 0207 described in the document 0205 are checked. A check content and an area are not limited to these. An instruction for another check content and another area can also be issued.

Processing for generating a scan ticket for checking a content described in the document 0205 based on the processing instruction sheet 0202 illustrated in FIG. 2 will be described below. The scan ticket is a ticket in which a method for recognizing a content of the instruction issued by the processing instruction sheet 0202 and checking the document to be checked, for example, the document 0205 is described in a format (e.g., a Quick Response (QR) code) that can be recognized by the image processing apparatus 0101.

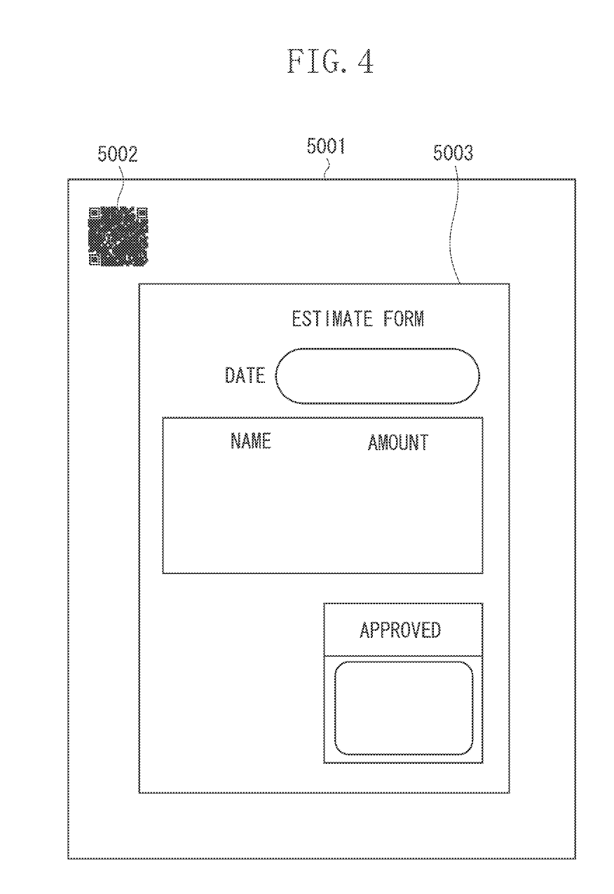

FIG. 4 illustrates a scan ticket generated from the processing instruction sheet 0202. A thumbnail image 5003 obtained by reducing the processing instruction sheet 0202 enables the user to understand a processing content by only seeing the scan ticket. An image 5002 includes an instruction content recognized from the processing instruction sheet 0202, position information relating to an area to which the instruction content is applied, location information (e.g., a front surface/a rear surface) relating to the thumbnail image 5003, coordinates of the thumbnail image 5003, a scale of the thumbnail image 5003, and data for specifying the scan ticket. At least the image 5002 coded into a format recognizable by the image processing apparatus 0101 and the thumbnail image 5003 of the document are added as additional information to the scan ticket.

When the document to be checked is checked, the scanner 0106 reads the scan ticket, and the CPU 0102 analyzes the scan ticket. A processing content recognized from an analysis result is checked for the scanned document to be checked.

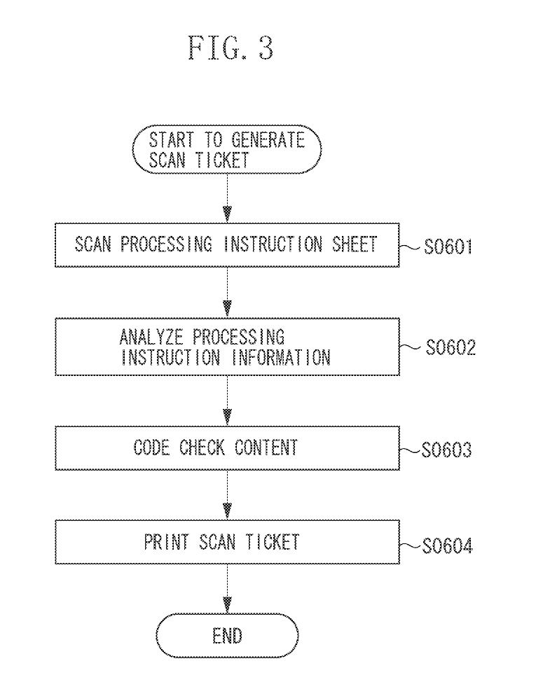

FIG. 3 is a flowchart illustrating a flow of processing for generating the scan ticket illustrated in FIG. 4 in the present exemplary embodiment. The flowchart illustrates the flow of processes for the CPU 0102 to load a program stored in the ROM 0110 into the RAM 0109 and execute the program.

If the user gives an instruction to generate a scan ticket via the operation unit 0107, the processing in the flowchart is started. In step S0601, the CPU 0102 causes the operation unit 0107 to display a screen for prompting the user to set a document in which processing instruction information has already been described (corresponding to the processing instruction sheet 0202). If the user sets the document and presses an OK button, the CPU 0102 reads the document using the scanner 0106. Image data obtained by reading with the scanner 0106 is stored in the RAM 0109.

In step S0602, the CPU 0102 then analyzes and recognizes the processing instruction information from the image data input from the scanner 0106. The CPU 0102 performs analysis as to at which portion on the document an instruction color of the processing instruction information registered by the user exists based on setting information registered in advance, and recognizes the color of the portion to specify a position of a processing target area for each color. The specified position enables determination at which position on the document the processing target area exists and which size the processing target area has. For example, the position is specified by coordinates. The specified position, the instruction color, and a processing content are associated with one another and stored as analysis information in the RAM 0109. For example, the analysis information is as follows:

In the following example, the setting information registered in advance by the user includes “Check whether a date is correctly entered for an area surrounded in blue” and “Check whether a seal is correctly put for an area surrounded in red”.

### <Analysis Information>

Area 1
Position: (2100, 1500)˜(4000, 2000)
Blue: Check date
   Designated period: 2009/01/01˜2009/04/30
Area 2
Position: (3000, 5500)˜(4000, 6500)
Red: Check seal
   Designated personal seal: Department manager's seal

In step S0603, the CPU 0102 codes the analysis information. “Coding of analysis information” means performing coding using a two-dimensional code (e.g., a QR code), for example. While the two-dimensional code is taken as an example, the present invention is not limited to this. For example, something other than the two-dimensional code may be used to perform coding as long as it can be analyzed and recognized by the image processing apparatus 0101.

In step S0604, the CPU 0102 adds information relating to a thumbnail image to the analysis information coded in step S0603, and outputs and prints an addition result onto recording paper with the printer 0105. In the present exemplary embodiment, the thumbnail image 5003 is printed together with the QR code 5002 generated in step S0603.

Completed estimate forms are counted using the scan ticket generated as above.

More specifically, a generated scan thicket 5001 and a plurality of estimate forms 0205 to be processed are set on the document feeding device, and are collectively scanned. A device reads a processing content and a processing area described in the scan ticket 5001, and recognizes information relating to the processing content and the processing area. The device subjects the estimate form which is read next to the scan ticket to recognized processing. In the example previously described, recognition processing is performed every time the one estimate form is scanned as to whether an appropriate date is entered into the area 1 and whether a seal is correctly put on the area 2. When the processing is terminated for all the estimate forms, the device displays results of the recognition processing for the user.

For example, the results are displayed so that the user can recognize how many estimate forms recognized as one in which an appropriate date is not entered into the area 1 or a seal is not correctly put on the area 2 are scanned and what number estimate form are them.

The flow of processing for generating a scan ticket obtained by newly adding an instruction content to the scan ticket already generated will be described below.

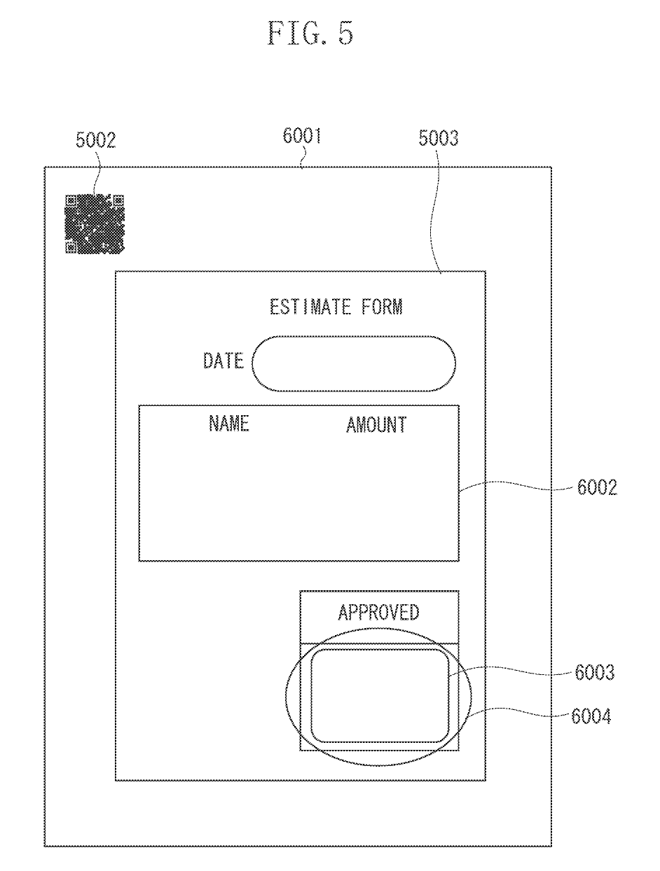

FIG. 5 illustrates a scan ticket in which a new instruction added thereto by the user designating a new area 6002 in the thumbnail image 5003 in the generated scan ticket 5001. In the present exemplary embodiment, it is assumed that the area 6002 represents an instruction to check an item/amount which can be designated in green, for example. This is referred to as write-once additional information.

An instruction content can be deleted by surrounding an area 6003 which has been already designated with a marker in a color for instruction deletion. The area 6003 already designated is surrounded in a color for deletion (e.g., yellow) to delete a content of the instruction in the area 6003. This is referred to as deletion additional information.

Setting information relating to the color and the processing (designated processing is not performed for an area surrounded in yellow) is together set when the user registers the setting information, as described above.

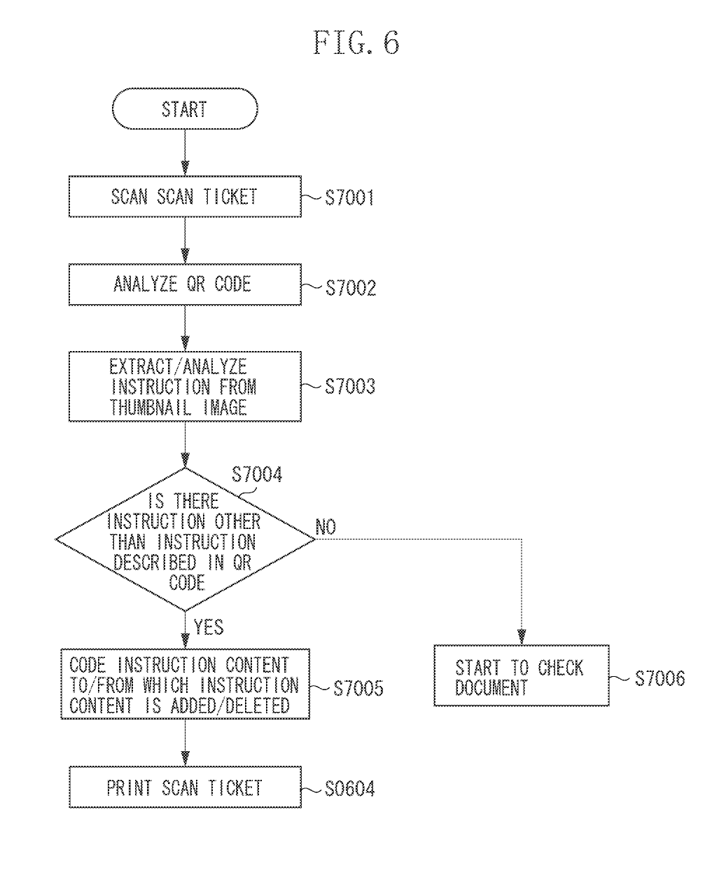

FIG. 6 is a flowchart illustrating the flow of processing for adding an instruction content and generating a new scan ticket from a scan ticket 6001 having write-once additional information. The flowchart illustrates the flow of processes for the CPU 0102 to load a program stored in the ROM 0110 into the RAM 0109 and execute the program.

If the user gives an instruction to generate a scan ticket via the operation unit 0107, the processing in the flowchart is started. In step S7001, the CPU 0102 causes the operation unit 0107 to display a screen for prompting the user to set the scan ticket. If the user sets the scan ticket including the write-once additional information, and then presses the OK button, the CPU 0102 reads the document with the scanner 0106. Image data obtained by reading with the scanner 0106 is stored in the RAM 0109.

In step S7002, the CPU 0102 then analyses and recognizes the QR code from the image data input from the scanner 0106. When the scan ticket 6001 is used, for example, analysis information is as follows:

### <Analysis Information>

This image data represents a scan ticket.

### Area 1

Position: (2100, 1500)˜(4000, 2000)
Blue: Check date

### Area 2

Position: (3000, 5500)˜(4000, 6500)
Red: Check seal
   Location of thumbnail image: Front surface
   Scale of thumbnail image: 70%
   Position of thumbnail image: (500, 4500)˜(600, 6500)

In step S7003, the CPU 0102 analyzes and recognizes processing instruction information relating to the thumbnail image from the image data input from the scanner 0106. Processing for analyzing and recognizing the thumbnail image is performed using various types of information relating to the thumbnail image obtained from the QR code. The details of the processing for analyzing and recognizing the thumbnail image is similar to that in step S0602. Information relating to the thumbnail image thus obtained is also stored in the RAM 0109.

For example, an analysis result of the thumbnail image in the scan ticket 6001 to/from which the instruction content is added/deleted is as follows:

### Area 1

Position: (2100, 1500)˜(4000, 2000)
Blue: Check date
   Designated period: 2009/01/01˜2009/04/30

### Area 3

Position: (1000, 2200)˜(4000, 3500)
Green: Check item/amount

In step S7004, the CPU 0102 compares the analysis information relating to the QR code stored in the RAM 0109 in step S7002 with the analysis result of the thumbnail image stored in the RAM 0109 in step S7003. The CPU 0102 determines whether the instruction described in the analysis result of the thumbnail image exists in an instruction other than the instruction described in the analysis information relating to the QR code or whether the instruction described in the analysis information relating to the QR code exists in an instruction other than the instruction described in the analysis result of the thumbnail image.

If the scan ticket 6001 having an instruction content added thereto is used, for example, the CPU 0102 determines that information described below is an instruction other than the instruction already described in the analysis information relating to the QR code:

<Analysis information>

### Area 3

Position: (1000, 2200)˜(4000, 3500)
Green: Check item/amount
   The CPU 0102 determines that information described below is an instruction deleted from the analysis information relating to the QR code because it detects that the area 6004 is surrounded in a color for deletion (yellow) on the thumbnail image.

### Area 2

Position: (3000, 5500)˜(4000, 6500)
Red: Check seal
   Designated personal seal; Department manager's seal+manager's seal

If the instruction other than the instruction described in the analysis information relating to the QR code exists (YES in step S7004), the processing proceeds to step S7005. In step S7005, the CPU 0102 codes its instruction content like that in step S0603. Then, in step S0604, the CPU 0102 newly prints the scan ticket.

If the instruction other than the instruction described in the analysis information relating to the QR code does not exist (NO in step S7004), the processing proceeds to step S7006. In step S7006, the CPU 0102 starts to directly check the document according to the analysis information relating to the QR code. Therefore, the CPU 0102 displays a content for prompting the user to set the document on the document feeding device on the operation unit 0107.

As described above, according to the present exemplary embodiment, the scan ticket obtained by adding the new instruction to the scan ticket already generated can be easily generated. Further, the scan ticket which is generated once and used can be reused. Therefore, a scan ticket having high reliability can be generated.

If the new instruction is added to the thumbnail image in the scan ticket, the CPU 0102 prints the new scan ticket. However, the CPU 0102 may start to check the document according to information having the new instruction added thereto without printing the scan ticket.

In the first exemplary embodiment, when the instruction other than the instruction described in the QR code is extracted from the thumbnail image, the scan ticket that reflects its instruction content is output. The user may confirm the added instruction content. In a second exemplary embodiment, a method for displaying an added instruction content on an operation unit 0107 will be described.

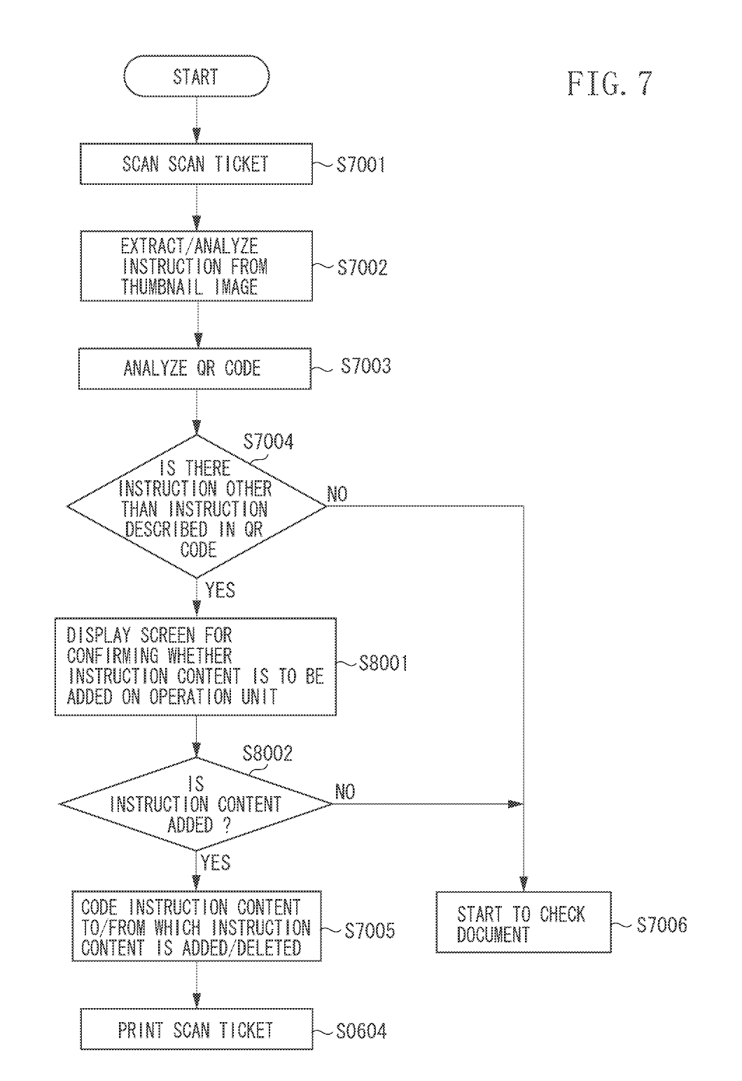

FIG. 7 is a flowchart illustrating the flow of processing for registering a scan ticket in the second exemplary embodiment.

Steps S7001 to S7004 are similar to those illustrated in FIG. 6.

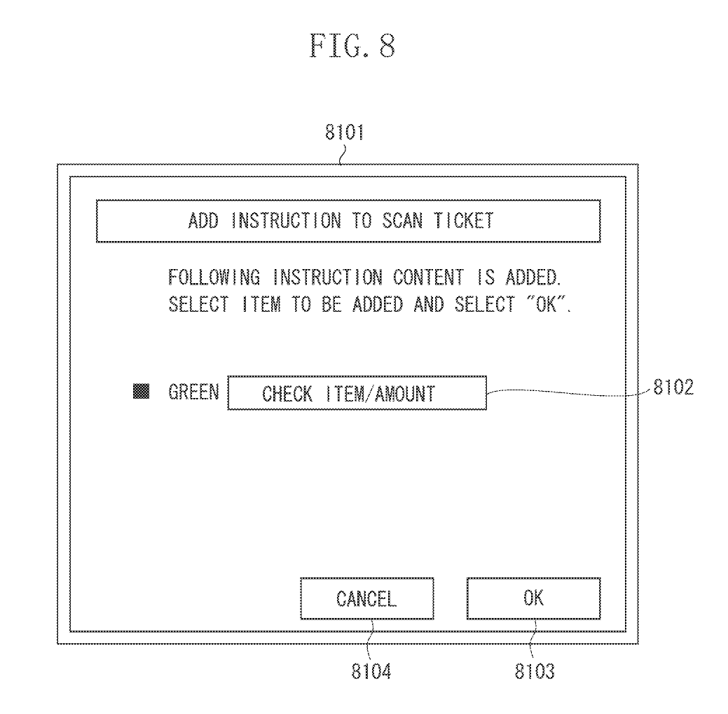

If an instruction other than an instruction described in a QR code 5002 is extracted from a thumbnail image (YES in step S7004), the processing proceeds to step S8001. In step S8001, a CPU 0102 displays a screen as illustrated in FIG. 8 on the operation unit 0107.

In step S8002, the CPU 0102 determines whether an instruction content is to be added. In this case, a screen 8101 displayed for a user is a screen for the user to confirm whether an instruction is added, on which a content of the added instruction is displayed. As described on a column 8102, an instruction content “Check item/amount” is added. The user selects the column 8102, and presses an OK button 8103 when using the added instruction content. When the added instruction content is not used, the user presses a cancel button 8104.

If the instruction content is added (YES in step S8002), the processing proceeds to step S7005. In step S7005, the CPU 0102 codes the instruction content like that in step S0603. In step S0604, the CPU 0102 newly prints a scan ticket.

If the instruction content is not added (NO in step S8002), the processing proceeds to step S7006. In step S7006, the CPU 0102 starts to directly check a document according to analysis information relating to the QR code 5002. Therefore, the CPU 0102 displays a content for prompting the user to set the document on the document feeding device on the operation unit 0107.

As described above, according to the second exemplary embodiment, the user confirms the updated instruction content via the operation unit 0107, and then reflects the confirmed instruction content on the scan ticket. Therefore, the user can reliably add the instruction content, as intended.

In the first and second exemplary embodiments, the instruction content is directly added to the thumbnail image in the scan ticket. Therefore, the scan ticket before the addition does not remain on user's hand. The scan ticket may be desired to be newly generated from a state before the addition. In a third exemplary embodiment, a method for simultaneously outputting a scan ticket from which an added instruction content is omitted will be described.

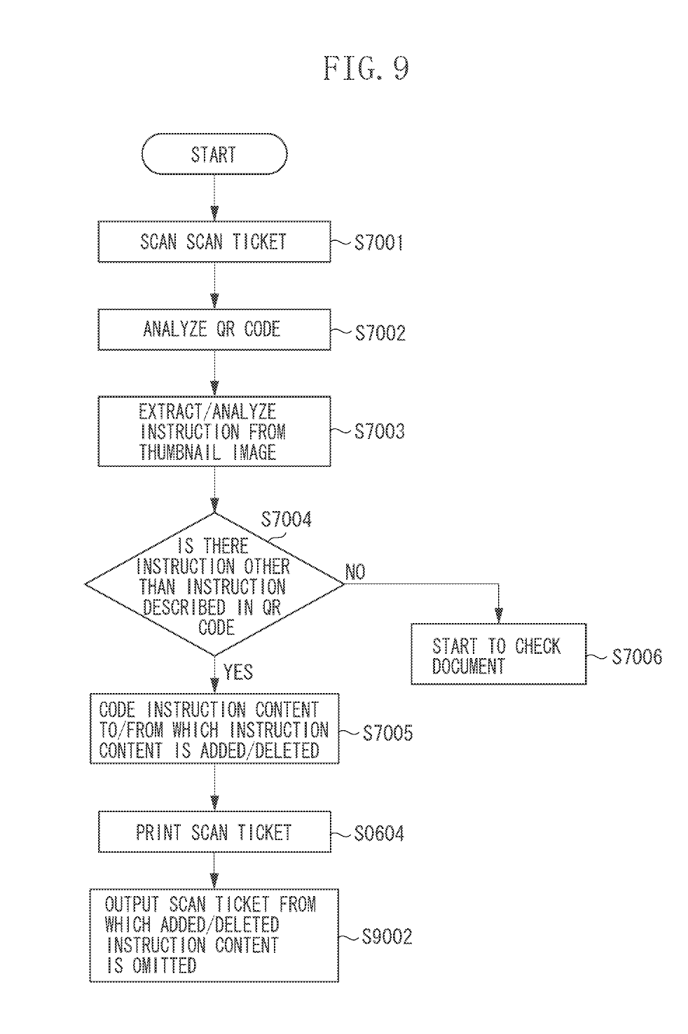

FIG. 9 is a flowchart illustrating the flow of processing for regenerating a scan ticket in the third exemplary embodiment. The flowchart illustrates the flow of processes for the CPU 0102 to load a program stored in the ROM 0110 into the RAM 0109 and execute the program.

Steps S7001 to S0604 are similar to those illustrated in FIG. 6.

In step S0604, the CPU 0102 prints a scan ticket to or from which an instruction content is added or deleted. In step S9002, the CPU 0102 then prints the scan ticket from which the added or deleted instruction content is omitted. If a scan ticket 6001 is scanned, a scan ticket 5001 from which areas 6002 and 6004 serving as added instructions are omitted is output.

Further, a QR code 5002 may include information relating the added or deleted instruction content (coordinates and a date) so that the scan ticket can be optionally returned to the previous state.

As described above, according to the third exemplary embodiment, the scan ticket after updating and the scan ticket before updating are output. Therefore, the scan ticket can simply be returned to any state that a user chooses.

When a part of a fine table is marked, there is a case that a marked area cannot be correctly recognized. Processing performed when the area is difficult to determine will be described.

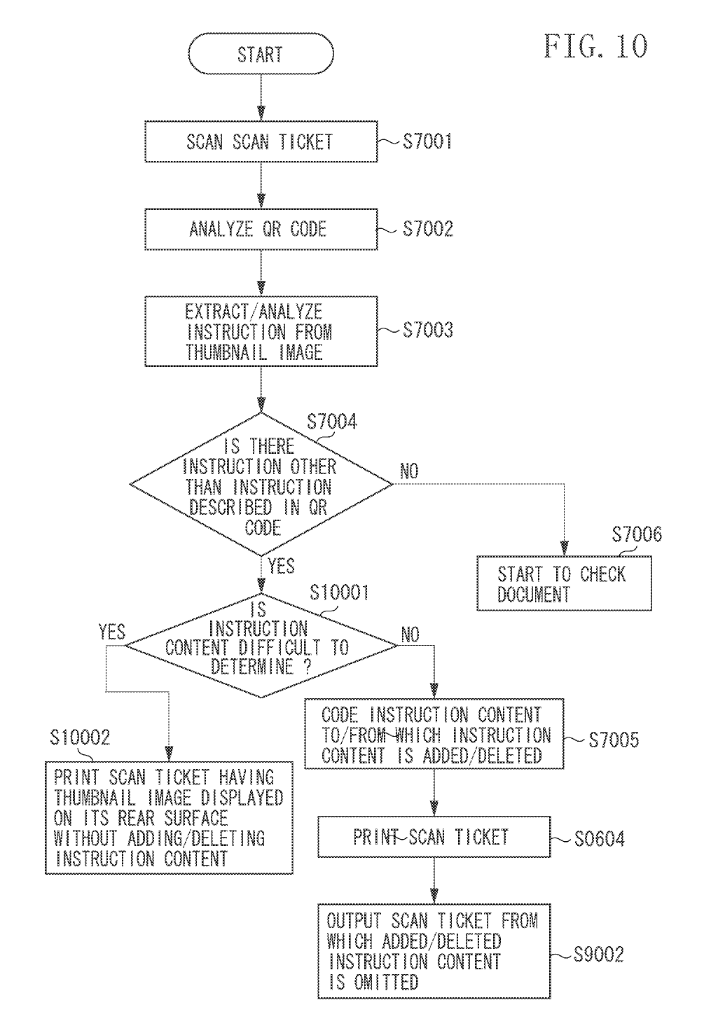

FIG. 10 is a flowchart illustrating the flow of processing for regenerating a scan ticket according to a fourth exemplary embodiment. The flowchart illustrates the flow of processes for the CPU 0102 to load a program stored in the ROM 0110 into the RAM 0109 and execute the program.

Steps S7001 to S7004 are similar to those illustrated in FIG. 6.

If an instruction other than an instruction described in a QR code 5002 is extracted from a thumbnail image (YES in step S7004), the processing proceeds to step S10001. In step S10001, the CPU 0102 attempts to analyze an instruction content.

If there is a plurality of closed sections in a designated area, and an instruction content is difficult to accurately determine, because, for example, the one closed section is difficult to recognize, the processing proceeds to step S10002. In step S10002, the CPU 0102 prints a scan ticket having a thumbnail image displayed on its rear surface without adding/deleting the instruction content. At this time, a location, a scale, a position, and others of the thumbnail image in the QR code 5002 are changed.

When a scan ticket 6001 is scanned according to the present exemplary embodiment, for example, analysis information described in the QR code 5002 in the scan ticket 6001 printed in step S1002 is as follows:

### <Analysis Information>

This image data represents a scan ticket.

### Area 1

Position: (2100, 1500)˜(4000, 2000)
Blue: Check date

### Area 2

Position: (3000, 5500)˜(4000, 6500)
Red: Check seal
   Location of thumbnail image: Rear surface
   Scale of thumbnail image: 100%
   Position of thumbnail image: (300, 5000)˜(300, 7000)

As can be seen from the analysis information, the thumbnail image is printed on the rear surface of the scan ticket, and the scale thereof is greater than that when it is printed on the original scan ticket. According to this processing, a thumbnail image can be drawn greater than a thumbnail image which is drawn on a scan ticket first put in.

A user marks the enlarged thumbnail image again.

As described above, according to the fourth exemplary embodiment, the thumbnail image is enlarged, so that the user can easily enter a new instruction into the scan ticket. Therefore, the user can designate an instruction area to be added or deleted, as intended.

When processing for adding an instruction to a scan ticket is repeated, a QR code cannot sufficiently contain data.

If it is determined that the QR code cannot sufficiently contain the data when a new scan ticket is generated, one QR code is added to contain the data. Coordinate information relating to the new QR code is added to the first QR code. If a position to which the QR code is to be added cannot be ensured, a location is ensured by reducing a thumbnail image.

As described above, according to a fifth exemplary embodiment, if pieces of instruction information are increased and the number of QR codes is increased, a location where the QR code is printed can be ensured by reducing the thumbnail image. Therefore, the scan ticket can be reliably generated.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-292838 filed Dec. 24, 2009, which is hereby incorporated by reference herein in its entirety.

What is claimed is:

1. An apparatus which extracts information from an instruction sheet serving as a document in which an instruction for a processing target area in a target document and a content for the area, reads a first ticket to which an image coded into a format recognizable by the apparatus and a thumbnail image of the document are added, and performs processing extracted from information added to the first ticket, the apparatus comprising:
a comparison unit configured to compare a second ticket, obtained by adding new information to the first ticket, with the first ticket; and
a generation unit configured to regenerate, if pieces of information included in the tickets differ in the comparison unit, the second ticket.

2. The apparatus according to claim 1, wherein the comparison unit configured to extract the information included in the first ticket from the coded image and the thumbnail image that are added to the first ticket.

3. The apparatus according to claim 1, wherein the apparatus displays a content of the regeneration performed by the generation unit for a user to confirm the content of the regeneration.

4. The apparatus according to claim 1, further comprising a unit configured to respectively output the second ticket and the first ticket.

5. The apparatus according to claim 1, further comprising a determination unit configured to determine whether the first ticket can be analyzed, and a unit configured to enlarge the thumbnail image in the document and output the enlarged thumbnail image to the first ticket if the determination unit determines that the ticket cannot be analyzed.

6. The apparatus according to claim 1, further comprising a unit configured to add to the coded image information for specifying a position of another coded image in the first ticket.

7. A method for controlling an apparatus which extracts information from an instruction sheet serving as a document in which an instruction for a target area in a processing target document and a content for the area, reads a first ticket to which an image coded into a format recognizable by the apparatus and a thumbnail image of the document are added, and performs processing extracted from information added to the first ticket, the method comprising:
comparing a second ticket, obtained by adding new information to the first ticket, with the first ticket; and
regenerating, if pieces of information included in the tickets differ in the comparison, the second ticket.

8. The method according to claim 7, further comprising extracting the information included in the first ticket from the coded image and the thumbnail image that are added to the first ticket.

9. The method according to claim 7, further comprising displaying a content of the regeneration for a user to confirm the content of the regeneration.

10. The method according to claim 7, further comprising respectively outputting the second ticket and the first ticket.

11. The method according to claim 7, further comprising determining whether the first ticket can be analyzed, and enlarging the thumbnail image in the document and outputting the enlarged thumbnail image to the first ticket if it is determined that the ticket cannot be analyzed.

12. The method according to claim 7, further comprising adding to the coded image information for specifying a position of another coded image in the first ticket.

13. A computer-readable recording medium having computer-executable instructions for performing a method performed in an apparatus which extracts information from an instruction sheet serving as a document in which an instruction for a target area in a target document and a processing content for the area, reads a first ticket to which an image coded into a format recognizable by the apparatus and a thumbnail image of the document are added, and performs processing extracted from information added to the first ticket, the method comprising:
comparing a second ticket, obtained by adding new information to the first ticket, with the first ticket; and
regenerating, if pieces of information included in the tickets differ in the comparison, the second ticket.

14. The computer-readable recording medium according to claim 13, further comprising extracting the information included in the first ticket from the coded image and the thumbnail image that are added to the first ticket.

15. The computer-readable recording medium according to claim 13, further comprising displaying a content of the regeneration for a user to confirm the content of the regeneration.

16. The computer-readable recording medium according to claim 13, further comprising respectively outputting the second ticket and the first ticket.

17. The computer-readable recording medium according to claim 13, further comprising determining whether the first ticket can be analyzed, and enlarging the thumbnail image in the document and outputting the enlarged thumbnail image to the first ticket if it is determined that the ticket cannot be analyzed.

18. The computer-readable recording medium according to claim 13, further comprising adding to the coded image information for specifying a position of another coded image in the first ticket.
